(19) United States
(12) Patent Application Publication
(10) Pub. No.: US 2009/0231111 A1
(43) Pub. Date: Sep. 17, 2009

(54) METHOD AND APPARATUS FOR ENTERTAINMENT COMPRISING RFID TAGS

(75) Inventor: Jan Oechsle Hansen, Aarus (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: MARTIN PROFESSIONAL A/S, Aarhus N (DK)

(21) Appl. No.: 11/993,166

(22) PCT Filed: Jun. 22, 2006
(86) PCT No.: PCT/DK06/00365

§ 371 Date: Dec. 19, 2007

(30) Foreign Application Priority Data
Jun. 24, 2005 (DK) PA 2005 00935

(51) Int. Cl. H04Q 5/22

(52) U.S. Cl. 340/10.51

(57) ABSTRACT

The present invention relates to a method and an apparatus primarily for entertainment, which method or apparatus comprises an electronic control system, comprising at least one processor, which processor controls and stores at least some operational parameters during operation of the apparatus. The scope of the invention is to achieve access to data stored in an entertainment system or apparatus in periods of non-operation. This can be achieved if the apparatus comprises a RFID tag, which RFID tag can be communicating with the processor during operation, which RFID tag comprises at least one memory, which memory can contain copy of data segment representing at least one operational parameter for the apparatus, which RFID tag can be accessible from outside the apparatus in an operational or non-operational period, where an external device can read or write in the data segment in the memory in the RFID tag. It is hereby achieved that data could be transmitted in and out of the RFID tag during operation of an apparatus. Data transmitted out from the RFID tag could be information about addresses for normal communication with the apparatus using the DMX protocol as an example. These addresses could then be exchanged from the outside if the address for a specific apparatus has to be changed. After operation of an entertainment apparatus, for example when it is ready for transportation for a performance, an RFID scanner could be used to control failures or critical parameters in the apparatus so that apparatuses that show any critical parameters are sent for repair while operators showing normal activity will be transported for the next show.

### FIELD OF THE INVENTION

The present invention relates to an apparatus primarily for entertainment, which apparatus comprises an electronic control system, comprising at least one processor, which processor controls and stores at least some operational parameters during operation of the apparatus.

The present invention also relates to a method for establishing access to information representing operational parameters in units interconnected in an entertainment system comprising a number of interconnected units.

### BACKGROUND OF THE INVENTION

It is well known to use RFID tags for logistic use during production of goods. This is described in WO 00/45324 which describes a method for production and operations management comprising the steps of: associating a read/write RFID tag with a product to be processed; subjecting the product to at least one process; and writing information to the associated tag relating to the at least one process, whereby application of the at least one process to the product can be confirmed by reading the information from the associated tag. The method can further comprise the steps of: subjecting the product to a further process; reading from the associated tag the information relating to the at least one process; modifying the further process in accordance with the read information; and writing further information to the associated tag related to the further process. The processes can include, for example, at least one of a manufacturing process, an inspection process, a shipping process, a warehousing process and a retailing process.

The document described above only concerns the use of read/write RFID tags during a production process. All items have RFID tags connected thereto, and these RFID tags contain information related to the production process or further after production, for storage and shipping. There is no indication in this document that the items as such during operation are communicating into the RFID tags.

### OBJECT OF THE INVENTION

The scope of the invention is to achieve access to data stored in an entertainment system or apparatus in periods of non-operation.

### DESCRIPTION OF THE INVENTION

This can be achieved if the apparatus comprises a RFID tag, which RFID tag can be communicating with the processor during operation, which RFID tag comprises at least one memory, which memory can contain copy of data segment representing at least one operational parameter for the apparatus, which RFID tag can be accessible from outside the apparatus in a non-operational period, where an external device can read or write in the data segment in the memory in the RFID tag.

It is hereby achieved that data could be transmitted in and out of the RFID tag during operation of an apparatus. The data transmitted into the RFID tag could for example be operational time on critical components such as lamps or electric motors. Also, maximum temperature measured in an apparatus could continuously be stored in the RFID tag. Data transmitted out from the RFID tag could be information about addresses for normal communication with the apparatus using the DMX protocol as an example. These addresses could then be exchanged from the outside if the address for a specific apparatus has to be changed. After operation of an entertainment apparatus, for example when it is ready for transportation for a performance, an RFID scanner could be used to control failures or critical parameters in the apparatus so that apparatuses that show any critical parameters are sent for repair while operators showing normal activity will be transported for the next show.

Also in theatres where a lot of entertainment apparatuses are in operation, these apparatuses could be communicated by an RFID reading/writing device in a situation where the apparatuses are prepared for operation. The RFID reading/writing instrument has to be placed near an apparatus to read/write all the parameters afterwards. Communication is possible by using the RFID tag during operation of an apparatus. It is hereby achieved that change in a address is possible after an apparatus is connected to power and data lines.

The apparatus can be a light fixture comprising light generating means connected to means for optical or mechanical manipulation of the light. It is hereby achieved that especially the lifetime of the lamp could be controlled because the actual time for the light in operation can be stored in the RFID tag. Especially light fixtures are often placed relatively high over a stage where the communication with the RFID tag make life much more easy for the persons who have to operate the lighting fixtures.

As an alternative, the apparatus can be a smoke generator, which smoke generator can comprise electronic regulation means for controlling mechanical smoke generating means. It is hereby achieved that technical failure information could be transmitted by the RFID tag, but also the content of tanks which contain liquids for smoke generation could be controlled so that the volume in the tanks is always present in the RFID tag in order to assure that the necessary chemicals are present for the next operation of the smoke generator.

As a further alternative, the apparatus can be a sound generator, which sound generator can comprise electronic regulation means for controlling electro/mechanical sound generating means. It is hereby achieved that technical parameters from the sound generator can be stored in the RFID tag. These parameters could be maximum power consumption and maximum temperature, but also other parameters could be stored this way.

The apparatus could be a controller unit, which unit could control a number of entertainment apparatuses. It is hereby achieved that also parameters from the controller unit which could be life time and temperature measured in the controller unit could be stored in the RFID tag. Also programming of the controller unit could take place by writing new information in the RFID tag in periods where the controller unit is not operating.

Preferably, some electronic, mechanical, electro/mechanical or optical devises in the apparatus can comprise RFID tags, which RFID tags can communicate with the processor means, where the processor means stores some data segments in a mother RFID tag, which mother RFID tag is accessible from outside during operation, transport, storage or test of the apparatus. In this way, it is achieved that all different modules, for example printed boards which are operating inside an apparatus could be connected with their own RFID tags. These RFID tags could have been placed on the printed circuit boards just during their production so they might have even production data stored in them for later reading. By letting each of the printed circuit boards operate with their own RFID tags, they can store a lot of different technical parameters and/or critical parameters could be communicated to the mother RFID which is the only one which has to be physically placed for access from the outside. The mother RFID could for example contain address information, which could be changed from the outside while programming an apparatus. This could be much more effective than for example the setting up of switches outside the apparatus before an apparatus can be in communication with a control system.

Instead, at least some electronic, mechanical, electro/mechanical or optical devises in the apparatus can communicate in or out of RFID tags, which RFID tags are accessible from outside during operation, transport, storage or test of the devices. It is hereby achieved that communication is possible to and from the devices by using an external communication unit.

The RFID tag can be operating with a power delivered from a receiving RF antenna placed in conjunction with the RFID tag. It is hereby achieved that the RFID tag only is operational when it receives an electromagnetic radiation, which can cooperate with the antenna and create the power supply in the RFID tag.

The RFID tag could instead be operating with a power delivered from a battery connected to the RFID tag. It is hereby achieved that the RFID tag is constantly operational because the power supply comes from the battery. This could lead to communication with the RFID tag over the greater distance.

This invention further comprises a method where units in a system for entertainment can comprise RFID tags, which RFID tags can be connected to processor means during operation of the unit, which RFID tags are accessible by an external terminal for reading or writing operational parameters in the interconnected units in operational periods and non-operational periods. It is hereby achieved that there is an effective way of communication with an apparatus also in periods when the apparatus is in a power down mode and also where the apparatus could be programmed during power down. Also, for logistic analyses, it will possible to read for example failure situations which are stored as coded information in the RFID tags.

### DESCRIPTION OF THE DRAWING

FIG. 1 shows a principal diagram of an entertainment unit, and

FIG. 2 is a table which table describes the typical content of a memory in an RFID tag.

### DETAILED DESCRIPTION OF THE INVENTION

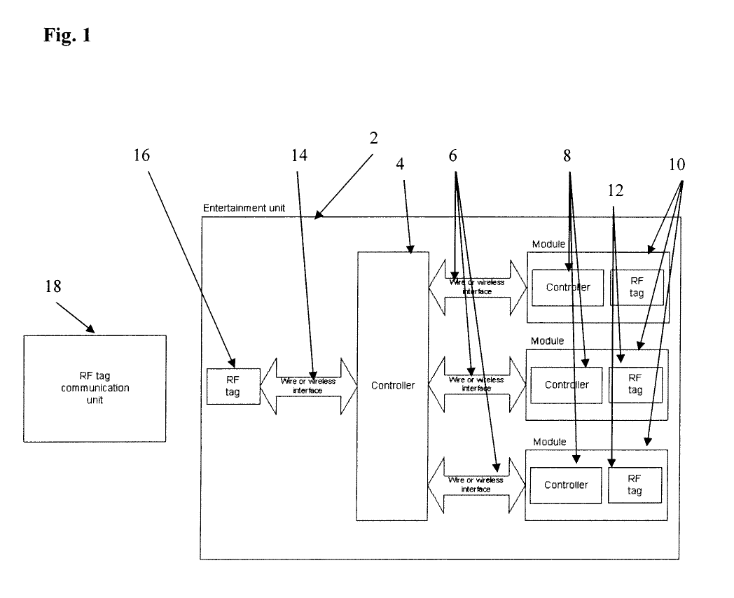

FIG. 1 describes an entertainment unit 2 which unit 2 comprises a controller 4 which controller 4 communicates with wire or wireless communication means 6 with different modules 10 which modules 10 contain controllers 8 and RF tags 12. The controller 4 is connected to a communication line 14 which could be wire or wireless interface towards and RFID tag 16 which could be the mother RFID tag. With 18, a RF tag communication unit is shown which communication unit could be an external device without any connection to the entertainment unit.

In operation, the controller 4 will communicate over the communication means 6 towards the controllers 8, which controllers can take care of different technical control operations inside the entertainment unit. This could be the control of the step motors or control of colour changing means. Each of the modules contains their own RF tag 12 where the controller can put selected information into the RFID tags 12. The RFID tags could contain programmable information which has to be used in the controller. This information could in principle be changed from the outside. The controller 4 is further connected through communication means 14 to the RFID mother tag 16 which could contain information from the different controllers 8 and the content of the RFID tags 12 simply because the RFID tag 16 is the only one which is physically placed so that it is accessible from the outside where it can communicate with the RF tag communication unit 18.

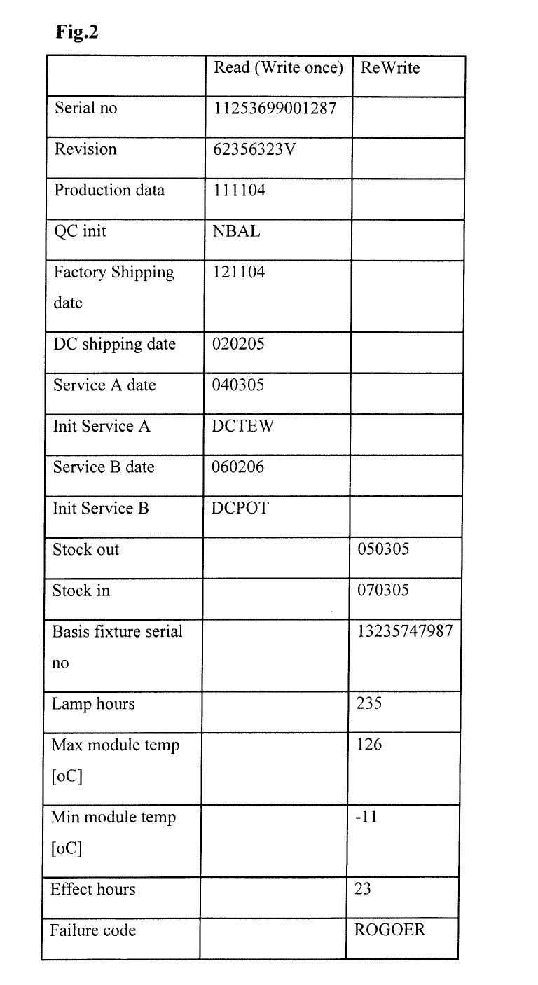

FIG. 2 shows a typical list of the content of an RFID tag.

A RFID tag is a radio frequency identification device communicating over a short distance with a communication unit. Information in the form of data segments can be transmitted to and from the RFID tag. The RFID tag also comprises means for communication to or from an electronic device.

1. An apparatus primarily for entertainment, which apparatus comprises an electronic control system, comprising at least one processor, which processor controls and stores at least some operational parameters during operation of the apparatus, characterized in that the apparatus comprises at least one RFID tag, which RFID tag is communicating with the processor during operation of the processor, which RFID tag comprises at least one memory, which memory contains copy at least one data segment representing at least one operational parameter for the apparatus, which RFID tag is accessible from outside the apparatus in an operational or non-operational period, where an external device reads or writes at least one data segment from the memory in the RFID tag.

2. An apparatus as described in claim 1 characterized in that the apparatus is a light fixture comprising light generating means connected to means for optical or mechanical manipulation of the light.

3. An apparatus as described in claim 1 characterized in that the apparatus is a smoke generator, which smoke generator comprises electronic regulation means for controlling mechanical smoke generating means.

4. An apparatus as described in claim 1 characterized in that the apparatus is a sound generator, which sound generator comprises electronic regulation means for controlling electro/mechanical sound generating means.

5. An apparatus as described in claim 1 characterized in that the apparatus is a controller unit, which unit controls a number of entertainment apparatuses.

6. An apparatus as described in claim 1 characterized in that at least some electronic, mechanical, electro/mechanical or optical devises in the apparatus comprises RFID tags, which RFID tags are communicating with the processor means, where the processor means stores some data segments in a mother RFID tag, which mother RFID tag is accessible from outside during operation, transport, storage or test of the apparatus.

7. An apparatus as described in claim 1 characterized in that at least some electronic, mechanical, electro/mechanical or optical devises in the apparatus are communicating in or out of RFID tags, which RFID tags are accessible from outside during operation, transport, storage or test of the apparatus or devices.

8. An apparatus as described in claim 1 characterized in that the RFID tag is operating with a power delivered from a receiving RF antenna placed in conjunction with the RFID tag.

9. An apparatus as described in claim 1
characterized in that the RFID tag is operating with a power delivered from a battery connected to the RFID tag.

10. A method for establishing access to information representing operational parameters in units interconnected in an entertainment system comprising a number of interconnected units, characterized in that units comprise RFID tags, which RFID tags are connected to electronic means during operation of the unit, which RFID tags are accessible by an external terminal for reading or writing operational parameters in or out of the interconnected units in operational periods and non-operational periods.

11. An apparatus as described in claim 5 characterized in that at least some electronic, mechanical, electro/mechanical or optical devises in the apparatus are communicating in or out of RFID tags, which RFID tags are accessible from outside during operation, transport, storage or test of the apparatus or devices.

12. An apparatus as described in claim 7 characterized in that the RFID tag is operating with a power delivered from a receiving RF antenna placed in conjunction with the RFID tag.

13. An apparatus as described in claim 7 characterized in that the RFID tag is operating with a power delivered from a battery connected to the RFID tag.

14. An apparatus as described in claim 5 characterized in that at least some electronic, mechanical, electro/mechanical or optical devises in the apparatus comprises RFID tags, which RFID tags are communicating with the processor means, where the processor means stores some data segments in a mother RFID tag, which mother RFID tag is accessible from outside during operation, transport, storage or test of the apparatus.
